(19) United States
(12) Patent Application Publication
(10) Pub. No.: US 2013/0312110 A1
(43) Pub. Date: Nov. 21, 2013

(54) PROTECTION OF APPLETS AGAINST HIDDEN-CHANNEL ANALYSES

(71) Applicants: Frederic Boulet, Issy Les Moulineaux (FR); Michael Barthe, Issy Les Moulineaux (FR); Thanh-ha Le, Issy Les Moulineaux (FR)

(72) Inventors: Frederic Boulet, Issy Les Moulineaux (FR); Michael Barthe, Issy Les Moulineaux (FR); Thanh-ha Le, Issy Les Moulineaux (FR)

(73) Assignee: MORPHO, Issy Les Moulineaux (FR)

(21) Appl. No.: 13/997,136

(22) PCT Filed: Dec. 22, 2011
(86) PCT No.: PCT/FR2011/053160

§ 371 Date: Jun. 21, 2013

(30) Foreign Application Priority Data
Dec. 24, 2010 (FR) 10 61252

(51) Int. Cl. G06F 21/14

(52) U.S. Cl. CPC G06F 21/14
USPC 726/26

(57) ABSTRACT

The invention relates in particular to an electronic device equipped with a virtual machine for executing an applet. The virtual machine is arranged so as to recognize the instructions of the applet and to execute a code corresponding to each instruction. The virtual machine comprises an association module arranged so as to associate several distinct but operationally identical codes with one and the same instruction, and a selection module arranged so as to select the code to be executed for said instruction in a random manner. The invention also relates to a method of securing a counter-electronic device against hidden-channel attacks.

The invention concerns methods for protecting applets against hidden-channel analyses as well as a device implementing such protection.

Applet means any program executed by a virtual machine. For example, a program drafted in Java Card language and intended to be executed by the JVM of a chip card is called an applet. By analogy, .NET applet or Multos applet designate programs developed in a .NET environment for chip cards (or respectively a Multos environment). The instructions included in an applet are often referred to as op-codes, standing for “operation codes”, in the Java Card context.

A virtual machine is an entity that is capable of executing an applet recorded in the form of a succession of instructions and which, when the applet is executed, translates each instruction into an elementary operation or a sequence of elementary operations and executes this or these elementary operations. A virtual machine makes it possible to dissociate the interface by means of which the program is recorded or transmitted, from the platform that performs the elementary operations. Examples of virtual machines comprise in particular JVMs (Java Virtual Machines), or various implementations of CLI (Common Language Infrastructure) such as CLR (Common Language Runtime), for C# language (.NET environment). Virtual machines are often purely software. They then make it possible to execute the same applet on all kinds of platform that are very different from one another, subject to there existing a virtual machine adapted for each of these platforms. However, it is also possible to use hardware virtual machines (for example a dedicated electronic circuit) or virtual machines associating a software part and a hardware part.

Reverse engineering of an applet means an activity with the purpose of understanding the way in which the applet was designed in order to copy, modify or divert the applet, usually without the agreement of its authors and/or holders.

A hidden-channel analysis is an analysis based on information obtained from the physical implementation of an electronic device. This information is often variations of certain physical quantities that are caused by the execution of a program in the electronic device. These physical quantities (called “hidden channels”) may in particular be the electrical consumption of the device, or the electromagnetic field that is produced by the device, and may make it possible to distinguish the tasks performed according to the electrical consumption that they require or the electromagnetic radiation that they cause. It is also possible to measure the vibrations emitted (some components are liable to vibrate, and this in a different manner depending on what they're doing), or the variations in temperature, or the time spent executing a particular task (“timing attacks”), etc.

An elementary analysis may consist simply of identifying a given characteristic according to a given measurement on the targeted electronic device. This is the case for example with so-called SPA (Simple Power Analysis) attacks. More sophisticated analyses may rely on statistical studies on the basis of a large number of measurements (this is the case for example with DPA attacks, standing for Differential Power Analysis, and more particularly HODPA attacks, standing for High Order DPA).

In the context of Java Card, it is often sought to keep secret the series of instructions included in the applets in order to prevent some of these instructions being modified in order to divert the applet, or to change a result produced during an execution of the applet.

However, it is sometimes possible to find the series of instructions and constitute a program by analyzing hidden channels, as is explained in particular in Dennis Vermoen, “Reverse engineering of Java Card applets using power analysis”, MSc Thesis, Delft Technology University (performed in Riscure), 2006. This implies a potentially significant vulnerability of Java Card applets. Hidden-channel analysis has also been used by authorized organizations (for example Information Technology Evaluation Facility—ITSEF) to assess the security of Java Cards, as is explained in Serge Chaumette and Damien Sauveron “An efficient and simple way to test the security of Java Cards”, in Proceedings of 3rd International Workshop on Security in Information Systems (WOSIS 2005). Sagem Sécurité is the proprietor of a patent “Protection of a program interpreted by a virtual machine”, number FR 2903508 B1, proposing masking the instructions in order to protect against this type of analysis.

To attempt to discover the instructions of an applet an attacker may for example proceed in two steps.

In a characterization step, the attacker loads learning applets on the card (for some Java Cards, this manipulation is in fact authorized, for others it may be necessary to perform a first attack in order to load the learning applets). The learning applets are coded by the attacker in such a way as to enable him to characterize the instructions by corresponding models. A model corresponds to a signal linked to a hidden channel of an instruction. All the models then form a model base for the instructions that have been characterized.

In a detection step, the attacker measures the signal coming from a hidden channel during the execution of an applet that he wishes to discover. Next he uses the model base constructed in the characterization step in order to find the sequence of instructions of the applet. The detection is based on the coherence between the signal acquired during the detection step and the models stored in the base. One of the most simple measures of coherence is correlation.

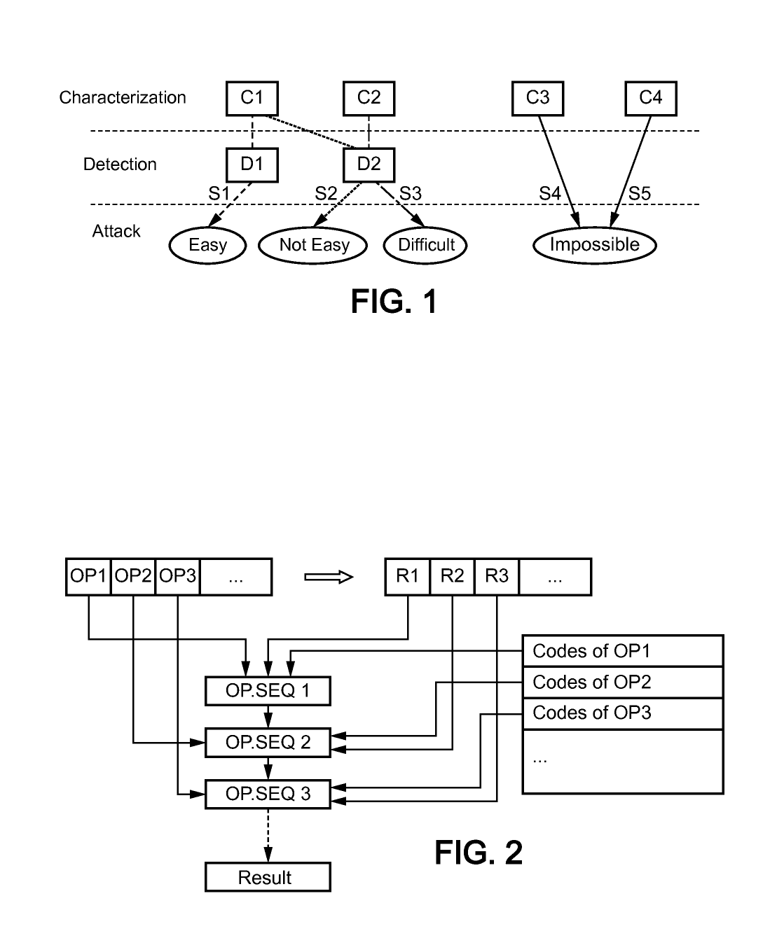

Thus the success of reverse engineering through the analysis of hidden channels generally depends on two steps of characterization and detection. With regard to the characterization step, an attacker may be confronted in particular with one of the following four situations, illustrated in FIG. 1:

C1—easy obtaining of correct models,

C2—difficult obtaining of correct models,

C3—impossibility of obtaining models,

C4—obtaining of false models.

Situation C1 corresponds for example to a case in which no hardware or software countermeasure is implemented, or only elementary (ineffective) countermeasures are implemented. A typical example of this type of countermeasure is the addition of a random noise on the channel (for example electrical consumption or electromagnetic radiation). However, this random noise can be isolated by executing the characterization applets a large number of times and averaging the signals.

Situation C2 may occur in particular if certain hardware or software countermeasures are implemented. The solution using a deterministic noise proposed in the patent FR 2903508 B1 makes it possible to make the extraction of the models more difficult. Countermeasures for desynchronizing the signals (for example: jitter, clock division, etc.) may interfere with the obtaining of the models, but it is often possible to find them by means of signal processing techniques. The solution according to FR 2903508 B1 is relatively expensive in terms of performance. In addition, if the deterministic noise is not correctly generated (that is to say if it does not lead to signatures greatly resembling the signatures naturally generated when the instruction in question is executed), an attacker could manage to extract raw signals.

Situation C3 could present itself in the case of very strong protection, for example by means of low-level interventions, at a hardware level, directly in a component executing the applet, or at a software level, in an interpreter (a virtual machine executing the applet). The purpose of these interventions is generally to make the models either constant, or non-constant but identical, so that it is impossible to distinguish one warning instruction from another. However, in practice it is very difficult to guarantee such a property, and case C3 is relatively theoretical.

Situation C4 may present itself when the device attacked is designed to supply false models (that is to say models that do not correspond to the models of the attacked applet), during the learning phase. According to the patent FR 2903508 B1 it is possible to create false types of noise, that is to say to generate different types of noise in the two characterization and detection steps, in order to interfere with detection. However, the models (hidden behind the noise) are typically the same. If the attacker manages to find a means for isolating the additive noise (for example isolating a signal coming from the cryptoprocessor that is used as noise), it is possible that he may manage to carry out reverse engineering of the applet attacked by hidden-channel analysis.

It can generally be considered that possibilities C3 and C4 cannot give rise to a detection step. Possibilities C1 and C2 for their part in general allow detection of the instructions in the second step in which two situations can be envisaged:

D1—models easy to detect during execution,

D2—models difficult to detect.

The situation in which it would be impossible to detect the models is in general the result of situation C3, and is therefore not studied.

Five of the scenarios that may occur in applet reverse engineering by hidden-channel analysis are shown in FIG. 1 by S1, S2, S3, S4 and S5. The combination C2-D1 is typically very rare. This is because, if it is difficult for the attacker to create characterization applets in order to observe the target device and determine models, it is probable that the subsequent detection phase will also be difficult because of the uncertainty weighing on the quality of the models.

In order to guard against these attacks, it is possible to protect the electronic device itself. For example, it is possible to superimpose a noise on the electrical supply in order to make exploitation thereof more difficult, to smooth the electrical consumption (for example with capacitors), to limit the electromagnetic emissions by suitable shielding, etc. It is also possible to use a special internal clock, with the feature of having an operating frequency that is variable randomly, which makes measurements difficult to use, the instructions of the applet then being performed at a rate that continuously varies and which is a priori unknown to the attacker). There also exist other techniques, consisting for example of controlling the physical access and/or logic access to the electronic device. For example, Java Card chip cards may make the execution of an applet conditional on the correct presentation of a PIN code. Thus a person who stole the chip card hoping to extract information therefrom could not execute the targeted applet without presenting the correct PIN code (which a careful user learns by heart and does not communicate to anyone), and would therefore not be in a position to make the attack.

WO 02/50641 (Nicolas Giraud et al) discloses a technique for protecting the execution of an operator (in particular the XOR operator) forming part of the set of arithmetic instructions of a microprocessor. This technique consists of replacing the execution of the same operator with the execution of one from several possible sequences of operations, the various sequences being functionally identical to the operator. However, this technique protects an operator without making any distinction as to the context in which this operator is used. Moreover, it is not designed to specifically protect an electronic device equipped with a virtual machine (this type of electronic device not even being disclosed).

However, these countermeasures are imperfect.

The invention aims to improve the situation.

One aspect of the invention concerns an electronic device equipped with a virtual machine for executing an applet, the virtual machine being arranged so as to recognize the instructions of the applet and to execute a code corresponding to each instruction. The electronic device is for example a chip card (SIM, bank card, health card, etc.), an electronic identity document (electronic passport, electronic identity card, electronic visa, etc.), a USB key, a token, etc. The virtual machine comprises an association module arranged to associate, with the same instruction, several codes that are distinct but functionally identical. Thus, the virtual machine has several ways of executing the same instruction. It is possible to protect several instructions, each of them being associated with several distinct but functionally identical codes. The definition of the sets of codes to be associated with each instruction can be done upstream (for example when the device is designed), and the association module can then merely store the list of predefined codes associated with each instruction concerned. The virtual machine also comprises a selection module arranged to select the code to be executed from the relevant instruction randomly. Randomly means that it is not possible, for an entity external to the device, to easily deduce deterministic properties that would make it possible to predict the future selections according to past selections. The selection may take place for example by means of a so-called “pseudo-random” generator, such as a linear congruential generator, which may be software or hardware. The series of random numbers generated by such a generator is deterministic, but of long period, and relies on a secret that is not shared with the outside. The association module and the selection module are for example software modules executed by a processor of the device, or wired logic (for example from a virtual machine produced by means of a dedicated electronic component).

Thus successive executions of the same applet using an instruction associated with several codes give rise to different observations and make it very difficult to deduce from these observations what is actually happening in the applet. This protection is advantageous since one of the features normally emphasized for devices using interpreters (for example Java chip cards) is their open character, and therefore the possibility for a third party to load applets. A dishonest user of the device would seek to take advantage of this opening to load learning applets and attempt to attack the device.

This embodiment is also advantageous in that it affords protection implemented at a higher level than the level of the processor. It is thus possible to protect certain instructions when they are used by an applet executed by a virtual machine. This protection may be added to a low-level protection, for example the processor may in addition replace certain operations of the processor with one from several functionally equivalent sequences. As a general rule, an electronic device comprising a virtual machine may be led to execute numerous types of code, the applets of which constitute merely a subassembly. For example, some codes may correspond to portions of an operating system of the electronic device (or to softmasks), and may be executed without the virtual machine being acted on (or even informed of their execution).

According to one embodiment, the various codes associated with the instruction are distinguished through their duration of execution by the device. Thus, the duration of execution of an applet fluctuates unpredictably, not only globally (the total duration of execution of the applet), but also at the level of each instruction associated with several codes.

According to one embodiment, the various codes associated with said instruction are distinguished through the electrical consumption of the electromagnetic radiation that they generate when they are executed by the device. Thus measurements of electromagnetic radiation of electrical consumption when an applet is executed do not make it possible to easily deduce what the applet is in the process of doing, the electromagnetic (or consumption) signature being variable for each instruction associated with several codes.

According to one embodiment, the virtual machine is arranged to make the random selection of a code to be executed for each instruction associated with several codes by relying on a measurement of a physical characteristic of the device. For example, it is possible to measure, by means of an analogue to digital converter, the noise of a resistor, which has stochastic physical properties. The physical measurement or measurements can be used directly, or be used as seeds of a software pseudo-random generator, or be post-processed, for example by means of a cryptoprocessor) in order to improve their statistical properties. Relying on a physical characteristic increases the quality (the unpredictable character) of the selection.

According to one embodiment, two instructions each being associated with several codes, at least one of the codes associated with the first instruction has at least one characteristic common with one of the codes associated with the second instruction, the common characteristics comprising the duration of execution by the device as well as the electrical consumption and the electromagnetic radiation generated when the code is executed by the device. According to one embodiment, the common characteristics are limited to one or several of these three characteristics. Thus any attacker will sometimes be confronted with a situation in which two different instructions have however the same signature (that is to say the same duration of execution and/or the same electrical consumption and/or the same electromagnetic emissions), which makes it difficult to identify the instructions. To adapt the duration of execution, it is possible to fix on the longest duration (between the two instructions); however, it is recommended not to merely add a simple waiting loop to the fastest instruction since a waiting loop has an electromagnetic signature that is in principle different from that of any instruction. It is advised, instead of a simple waiting, to perform calculations or operations similar to those of the longest instruction, calculation or operations the results of which can be ignored. This is advantageous compared with an embodiment that would be limited to revealing the same instruction as being several distinct instructions (when this instruction is executed on several occasions). This is because this is liable to lead any attacker even further into error during the analysis of the signatures that he is liable to make.

According to one embodiment, the virtual machine is arranged to identify the most frequent instructions and to use several codes only for said most frequent instructions. The virtual machine can identify the most frequent instructions (for which several codes are available), for example using a pre-stored list of instructions (this list being defined for example when the device is designed). It is thus possible to determine statistically that such and such an instruction is more frequent. It is also possible to analyze the code of the applet in question in order to identify the most frequent instructions for this particular applet.

According to one embodiment, the five most frequent instructions are the instructions sload, sconst_{—}0, baload, getfield_a_this, sstore, and only these five instructions can be modified, or even any subset of these five instructions.

According to one embodiment, the most frequent instructions comprise one of the instructions from the instructions addition, subtraction, multiplication, modulo and exclusive OR, and advantageously only instructions belonging to this subset of instructions (addition, subtraction, multiplication, modulo and exclusive OR). Such elementary arithmetic instructions, which are very common, have a great probability of appearing in any applet, and to appear fairly often. By concentrating on the protection of a few very frequent instructions, the complexity of implementation of the protection can be minimized (by avoiding protecting all the set of instructions), while ensuring that the protection will be fairly effective (by means of the frequent appearance of the instructions chosen, which thus leads any attacker into error, the signature of these instructions constantly changing).

According to one embodiment, the virtual machine is arranged to identify the most sensitive instructions and to use several codes only for these most sensitive instructions. Thus, the most critical operations are protected (an attacker is often interested in only certain parts of the applet). Just as for the identification of the most frequent instructions, the identification of the most sensitive instructions may be static, that is to say the list of the most sensitive instructions may be pre-programmed in the virtual machine at the time of the design of the virtual machine and/or of the device that includes it. According to one embodiment, the most sensitive instructions comprise one of the instructions from the instructions implementing cryptographic algorithms as well as the access control instructions (in particular the instructions for verifying the PIN code, or passwords).

Another aspect of the invention concerns a method for protecting an electronic device against hidden-channel attacks, the electronic device being equipped with a virtual machine recognizing the instructions of an applet and executing a code corresponding to each instruction. One instruction (at least) being associated with several distinct but functionally identical codes, the virtual machine selects the code to be executed for this instruction associated with several codes randomly.

According to one embodiment, the various codes associated with said instruction are distinguished through their duration of execution by the device.

According to one embodiment, the various codes associated with said instruction are distinguished through the electrical consumption or electromagnetic radiation that they generate when they are executed by the device.

According to one embodiment, the virtual machine effects the selection of the code to be executed for said instruction by relying on a measurement of a physical characteristic of the device. This physical characteristic (electrical noise in a component sampled by an analogue to digital converter, etc.) cannot be used directly, but rather a parameter calculated from the physical characteristic, and which may for example have better statistical properties.

According to one embodiment, two instructions each being associated with several codes, at least one of the codes associated with the first instruction has at least one characteristic common with one of the codes associated with the second instruction, the common characteristics comprising the duration of execution by the device, as well as the electrical consumption and electromagnetic radiation generated when the code is executed by the device.

According to one embodiment, the virtual machine identifies the most frequent instructions and uses several codes only for said most frequent instructions.

Other aspects, aims and advantages of the invention will emerge from a reading of the description of one of its embodiments.

The invention will also be better understood by means of the drawings, on which:

FIG. 1 illustrates various scenarios of a reverse engineering of an applet by hidden-channel analysis;

FIG. 2 is a diagram illustrating an embodiment of applet protection implemented according to one embodiment of the invention.

According to one embodiment, the protection of a program interpreted by a virtual machine against reverse engineering using hidden-channel analysis (known as “side-channel analysis”) is based on the use of alternative models for making the characterization and detection phases more difficult.

An instruction (op-code) may thus correspond to several different codes, and therefore to several different models.

In addition, the same model may correspond to several different instructions. For example, an addition operation (ADD) is generally very close to the subtraction operation (SUB). It is possible to code the ADD and the SUB in such a way that their signatures are identical or very similar. For example, it is possible to envisage using the addition ADD, which takes as parameters two operands Op1 and Op2, in the following manner:

Read Op1

Read Op2

X=Complement Op2

Calculate Op1+Op2

Write Result in memory

It can be seen here that the complement of the second parameter of the operation is calculated but that the result of this calculation is not used. It is possible to implement the corresponding operation SUB in the following way:

Read Op1

Read Op2

X=Complement Op2

Calculate Op1+X

Write Result in memory

It can be seen that this SUB operation performs exactly the same steps as the ADD operation, except that it uses as a parameter, on line 4, the complement X instead of the parameter Op2. However, this is typically not observed on electromagnetic or other emissions generated by the execution of the ADD and SUB operations since only the address used changes (the address of X not being the address of Op2). However, reading a data item at a first address or at another address of the same memory component in principle generates the same traces. The result is an ADD operation that may be slightly slower than a conventional ADD operation since it calculates an apparently unnecessary complement X (which is not used subsequently), but on the other hand the fact that this complement is calculated makes it possible to obtain the same signature as for the SUB operation. According to one embodiment, the complement is a step performed in hardware fashion in parallel with the other steps, and does not slow down the ADD operation.

It is also possible to obtain the same signature for fairly different operations, for example an operation with one operand (complement, negation, shift by 1 bit, etc.) and an operation with two operands (addition, multiplication, etc.). It is possible in particular to read the unique operand twice in a row in order to simulate the reading of the two operands.

According to one embodiment, the models of the same instruction are different not only with regard to form (the consumption power, the electromagnetic radiation) but also with regard to duration (the execution time), for example by addition of unnecessary operations. The unnecessary operations may be NOP operations. It is advisable not to use solely NOPs for this type of task (artificial prolongation of the duration of execution) since it might then happen that an attacker would be in a position to locate the NOPs and to consider them to be indicators of “time padding”, the duration of execution of which must be deduced in order to determine the true duration of execution.

According to one embodiment, some models are enabled only for the applet stored in a certain type of memory (for example in ROM). ROM memory typically contains highly controlled applets since they have necessarily been “loaded” during a step of masking of the ROM component, which involves knowledge of the applet by the manufacturers responsible for manufacturing this ROM component, who therefore have the opportunity to verify its content. For many types of applet (and in particular for Java applets), it is easy (and known from the prior art) to obtain the source code of the applet even when only its binary code is available (which may be the case with the above manufacturers).

According to one embodiment, ROM models are not valid for applets loaded in memories other than ROM, such as EEPROM or FLASH memories, or battery-protected RAM. This is advantageous, since such (rewritable) memories are generally much more accessible than ROM and may in particular possibly be manipulated by attackers in order to store chosen characterization applets therein (which is impossible or at least may be made impossible in the case of ROM memory, because of a check by the aforementioned manufacturers and/or by their customers and/or prescribers).

According to one embodiment, the models are different depending on the memory areas. For example, some operating systems of electronic devices partition the rewritable memories (such as EEPROM and FLASH), defining at least:
a first area accessible to third parties for loading applets in a controlled fashion according to a first protection level, and
a second area accessible to the manufacturer of the device, for loading correctives (patches, softmasks, etc.) or applets (optionally applet updates), the second area generally being controlled according to a second protection level (often higher than the first protection level).

There may be supplementary areas in addition to the aforementioned two areas. The second protection level may be determined and non-modifiable whereas the first protection level may be modifiable. This first level may be modifiable for example by a telecommunications operator (typically in the case of electronic devices taking the form of SIM cards), by a financial institute (typically in the case of bank cards), or by any entity that has purchased the electronic device and made it available to an end user.

Thus, by adapting the models used according to the memory types and/or areas, it is even more difficult for an attacker to characterize the instructions, since the characterization applets possibly implemented by the attacker are not relevant for all the applets, and in particular for the applets stored in certain types of memory or in certain memory areas deemed to be more sensitive and not accessible to the attacker. This may in particular concern system applets, such as applets offering authentication functions or identity evidence sharing functions (credentials). The authentication functions may in particular comprise one or more biometric authentications (fingerprint check by “match-on-card” technique, iris check, etc.), password checks, PIN codes, etc. Functions of sharing identity evidence may comprise for example functions of PIN code sharing by a system applet for avoiding all the user applets of everyone having to request the same PIN code from the user, which would be detrimental to the user-friendliness of the electronic device (users are typically irritated at having to enter the same secret code several times), and would even generally be detrimental to security. This is because each new entry of a PIN code may be the subject of an attack (social engineering, for example a person observing the entry of the PIN and memorizing it, or a spy system of the key logger type, namely a key strike interceptor). In addition, each new transmission of a PIN code to the electronic device may potentially be the subject of an attacker.

The models of the same instruction are activated alternately according to certain rules defined for the application target. For example, all the models may be activated randomly, the rule for an applet being able to be determined according to the mechanism defined in patent application FR 2903508 (“Protection of a program interpreted by a virtual machine”, filed on 10 Jul. 2006), that is to say it is possible to take into account a digest of the applet (for example the result of an SHA-1 function applied to the binary code of the applet), so as to vary the models differently for the same instruction depending on whether it belongs to one applet or to another.

The alternative models may be applied to all the instructions or a set of the most critical instructions and/or the most called on. It is possible in particular to target for example the instructions accessing memories of the NVRAM or EEPROM type which, being great consumers of electricity, are often more easily detectable by analysis of consumption.

According to one embodiment, the effects generated by this countermeasure are as follows.

In the case where an attacker can characterize the models easily with raw signals (this situation may arise if the component leaks a great deal and no noise is added, or if the noise is added but it can easily be filtered), the use of alternative models increases the number of models to be determined by the attacker in the characterization phase and the number of candidates to be identified (matched) in the detection phase. Consequently the detection of models is made more difficult.

Thus an extraction of noise that attackers may attempt to implement in order to find the models linked to the instructions is made more complicated.

An attacker could be aware of the existence of different models used by the target electronic device for the same instructions (according to the context in which the instruction is executed by the device). Such an attacker may then seek to take into account this characteristic by attempting to determine the rule (or rules) used by the target electronic device for choosing one model rather than another. In a case where an attacker cannot characterize the models with raw signals or where he is obliged to record numerous occurrences of signals and then average these signals in order to reduce the noise:
If the rule or rules of the learning applet used by the attacker for determining the models and the rule or rules used by an electronic device using the applet to be attacked are not identical, the models of the same instruction obtained during two distinct phases are typically different. Consequently, the models obtained during the characterization phase cannot be used (since they are a priori false) in order to successfully find the instructions of the applet to be attacked. The attack thereby becomes much more difficult.
If the rule or rules are identical for the learning applet and the applet to be attacked, but the various codes used for each instruction are determined in a way such that the models associated with these codes do not have an identical duration and are not called on at the same moment, then it can be expected that the countermeasure according to this embodiment generates jitter and causes desynchronizations. By averaging the signals, the averaged models of the same instruction in the two steps (characterization and detection) are therefore not identical. Consequently, detection becomes more difficult.

According to one embodiment, only a few instructions are protected (the most frequent, that is to say those that are statistically called on frequently by the applets), which makes it possible to have a small impact on performance (of around a few percent, that is to say the speed of execution of the applet may be almost unchanged). Thus the simple fact of changing only one very frequent instruction (for example addition) by associating with it for example four possible codes instead of only one, may suffice to make an attack much more complex, while having a highly negligible impact both on the development time (at the stage of the design of the interpreter, device, applets, etc.) and on the performance (the protected applet being almost as fast as a non-protected applet according to this embodiment).

According to one embodiment, the most frequent instructions are: sload, sconst_{—}0, baload, getfield_a_this and sstore, and it is a subset of these instructions (or even all these instructions) that is protected.

Interpreters (for example of the JCVM type, standing for Java Card Virtual Machine) are often software developed in C language. It is then possible to modify the interpreter in this language, which has the advantage of great portability (it can easily be adapted from one device to another, which would for example have a processor of a different type).

An embodiment limited to protecting frequent instructions is particularly advantageous, in particular for products having high constraints affecting performance, such as a low memory capacity, a slow processor, etc. For example, chip cards have computing and storage resources much smaller than those of a conventional computer, and this embodiment is particularly suited to them.

Targeting only certain instructions also makes it possible to avoid a long development time and a large size of the interpreter. In addition, by generating jitter through the instructions associated with different codes (using codes with different execution times), the generation and detection of models of other instructions that have only one model is also interfered with.

FIG. 2 concerns implementation of applet protection according to one embodiment. In FIG. 2, OPi designates instruction number i (having the op-code OPi). Ri designates a rule of this applet corresponding to the instruction OPi. The rule Ri may for example define the selection algorithm of the codes to be executed for the instruction OPi. It may be a conventional pseudo-random algorithm, but may also be an algorithm which, although random in that it is not easily predictable, selects the different codes with unequal probabilities. OP.SEQi designates the step of execution of an instruction OPi in the sequence of instructions constituted by the applet. The code executed during Op.SEQi is not always the same; it depends firstly on the instruction OPi, which determines the function that must be performed by the code, and by the rule Ri, which determines which code (among all the codes performing this function) must be executed.

Thus a virtual machine according to the embodiment shown in FIG. 2 generates, from an applet represented by a series of instructions (OP1, OP2, OP3, . . . ), from a series of rules (R1, R2, R3, . . . ), and from a series of sets of codes (codes of OP1, codes of OP2, codes of OP3, . . . ), each set of codes being associated with an instruction, an execution sequence (OP.SEQ1, OP.SEQ2, OP.SEQ3, . . . ) performing the tasks provided in the applet, but using randomly chosen codes.

Naturally, the present invention is not limited to the embodiment described above by way of example; it extends to other variants.

Thus a device that may be a chip card has been described above. However, the device implementing the invention may also be for example mobile communication equipment, a contactless identification label, a contactless identification level reader, a chip card, a reader of such chip cards, an access control system etc. Types of chip card for which the invention may advantageously be implemented may in particular be health chip cards, identity or passport chip cards, bank chip cards, access control chip cards or chip cards supporting electronic games.

Protectable applets are not limited to Java Card applets, but may for example be .NET applets, or Multos applets.

1. Electronic device equipped with a virtual machine for executing an applet, the virtual machine being arranged to recognize the instructions of the applet and to execute a code corresponding to each instruction, characterized in that the virtual machine comprises an association module arranged to associate several distinct but functionally identical codes with the same instruction, and a selection module arranged to select the code to be executed for said instruction randomly.

2. Device according to claim 1, in which the various codes associated with said instructions are distinguished through their duration of execution by the device.

3. Device according to claim 1, in which the various codes associated with said instruction are distinguished through the electrical consumption or the electromagnetic radiation that they generate when they are executed by the device.

4. Device according to claim 1, in which the virtual machine is arranged to effect the random selection of the code to be executed for said instruction, relying on a measurement of physical characteristic of the device.

5. Device according to claim 1, in which, two instructions being each associated with several codes, at least one of the codes associated with the first instruction has at least one characteristic common with one of the codes associated with the second instruction, the possible common characteristics being the duration of execution of the code by the device, as well as the electrical consumption and the electromagnetic radiation generated when the code is executed by the device.

6. Device according to claim 1, in which the virtual machine is arranged to identify the most frequent instructions and to use several codes only for said most frequent instructions.

7. Device according to claim 6, in which the most frequent instructions comprise one of the instructions from addition, subtraction, multiplication, modulo and exclusive OR instructions.

8. Device according to claim 1, in which the virtual machine is arranged to identify the most sensitive instructions and to use several codes only for said most sensitive instructions.

9. Device according to claim 8, in which the most sensitive instructions comprise one of the instructions from the instructions using cryptographic algorithms as well as access control instructions.

10. Method for protecting an electronic device against hidden-channel attacks, the electronic device being equipped with a virtual machine recognizing the instructions of an applet and executing a code corresponding to each instruction, characterized in that, an instruction being associated with several distinct but functionally identical codes, the virtual machine selects the code to be executed for said instruction randomly.

11. Method according to claim 10, in which the various codes associated with said instruction are distinguished through their duration of execution by the device.

12. Method according to claim 10, in which the various codes associated with said instruction are distinguished through the electrical consumption or electromagnetic radiation that they generate when they are executed by the device.

13. Method according to claim 10, in which the virtual machine selects the code to be executed for said instruction by relying on a measurement of physical characteristic of the device.

14. Method according to claim 10, in which, two instructions being associated each with several codes, at least one of the codes associated with the first instruction has at least one characteristic common with one of the codes associated with the second instruction, the possible common characteristics being the duration of execution of the code by the device, as well as the electrical consumption and electromagnetic radiation generated when the code is executed by the device.

15. Method according to claim 10, in which the virtual machine identifies the most frequent instructions and uses several codes only for said most frequent instructions.
